(19) United States
(12) Patent Application Publication
(10) Pub. No.: US 2002/0040749 A1
(43) Pub. Date: Apr. 11, 2002

(54) Tire structure

(76) Inventor: Pin-Chun Liu, Da-Li City (TW)

Correspondence Address: CHARLES E. BAXLEY, ESQUIRE, 5TH FL., 59 JOHN STREET, NEW YORK, NY, 10038, US

(21) Appl. No.: 10/006,053

(22) Filed: Dec. 6, 2001

Related U.S. Application Data
(63) Continuation-in-part of application No. 09/487,184, filed on Jan. 19, 2000.

(51) Int. Cl. F16J 15/32

(52) U.S. Cl. 152/511; 277/309

(57) ABSTRACT

A tire structure includes an outer tire includes a tread and two sidewalls extending from two sides of the tread. Two lip portions are formed on each of two sidewalls of the outer tire so as to be engaged with a wheel rim. An inner member is located inside of the outer tire and two peripheral edges of the inner member are connected between two opposite insides of the two sidewalls of the outer tire. The positions where the two peripheral edges of the inner member are connected to the insides of the sidewalls are located above the two respective lip portions. A valve is connected to the inner member and communicates with a space defined between the outer tire and the inner member.

### FIELD OF THE INVENTION

This application is a Continuation-In-Part application of U.S. Pat. No. 09/487,184, filed on Sep. 19, 2000.

### BACKGROUND OF THE INVENTION

A conventional tire is shown in FIG. 1 and generally includes an outer tire 10, an inner tube 12 which is snugly connected to an inside of the outer tire 10 by pressure. A valve 100 is connected to the inner tube 12 and extends through a hole in the wheel rim 11. Air enters into the inner tube 12 via the valve 100 so that a large pressure is applied to the inner tube 12 so as to expand the outer tire 10. Two lip portions of the outer tire are engaged with the wheel rim 11. If a sharp object penetrates through the outer tire 10 and the inner tube 12, because the inner tube 12 is so thin so that the inner tube could explode and could hurt people. Furthermore, the manufacturers have to establish two different production lines to produce the inner tube and the outer tire that have different features. The inner tube 12 is difficult to be properly received in the inside of the outer tire 10 when engaging the outer tire 10 with the wheel rim 11. Besides, the inner tube 12 could be penetrated by the heads of spokes which extend through the rim 11 and the heads protrude from an inside of the rim. The inner tube snugly contacts the inside of the rim 11 and a protection strip (not shown) is used to wrap around the inside of the rim 11 to separate the heads of the spokes and the inner tube 12.

The present invention intends to provide a tire structure that has an inner member which has two sides adhered to the inside of the lip of the outer tire during the sulfurizing process. The valve is connected to the inner member so that air pressure is filled between the outer tire and the inner member via the valve. Therefore, the tire needs no inner tube.

### SUMMARY OF THE INVENTION

In accordance with one aspect of the present invention, there is provided a tire structure and comprising an outer tire including a tread and two sidewalls extending from two sides of the tread. Two lip portions are formed on each of two sidewalls of the outer tire and engaged with a wheel rim. An inner member has two peripheral edges thereof connected between two opposite insides of the two sidewalls of the outer tire. The positions where the two peripheral edges of the inner member are connected to the insides of the sidewalls are located above the two respective lip portions. A valve is connected to the inner member and communicates with a space defined between the outer tire and the inner member.

The object of the present invention is to provide a tire structure that has an inner member which is adhered to an inside of the sidewalls of the outer tire so that there is no inner tube required.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is an end cross sectional view to show a conventional tire structure;

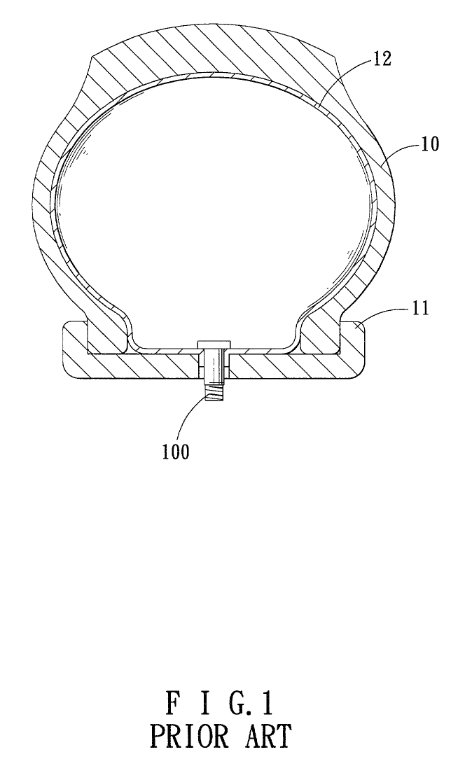

FIG. 2 is an end cross sectional view to show a tire structure of the present invention wherein air pressure not yet entered into the space between the inner member and the outer tire, and

FIG. 3 is an end cross sectional view to show air pressure enters into the space between the inner member and the outer tire to expand the outer tire and the inner member is pushed toward the wheel rim.

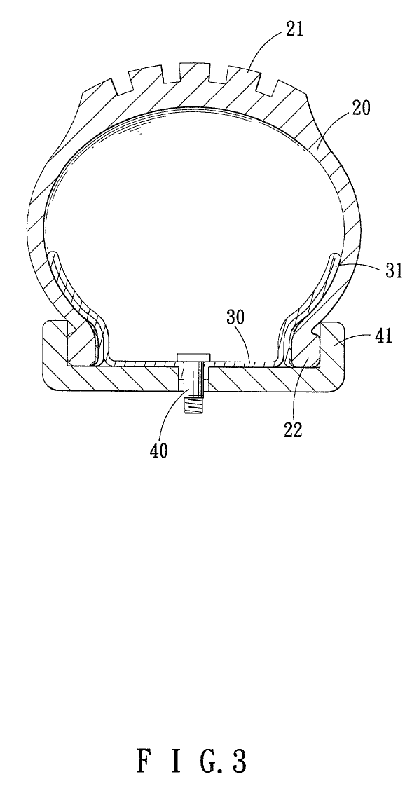

### DETAILED DESCRIPTION OF THE PREFERRED EMBODIMENT

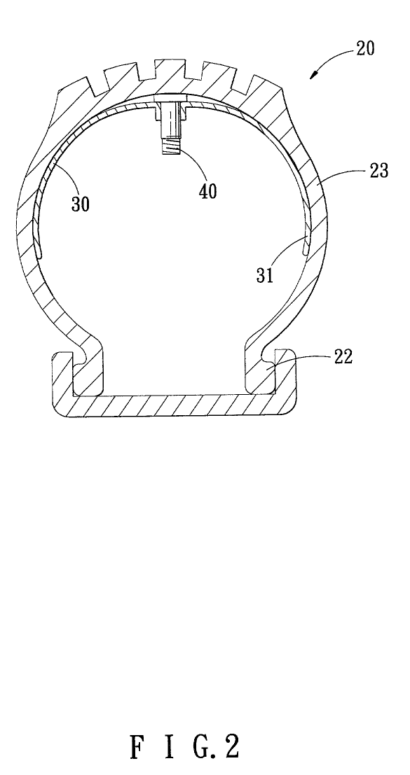

Referring to FIG. 2, the tire structure in accordance with the present invention comprises an outer tire 20 having a tread 21 and two sidewalls 23 extend from two sides of the tread 21. Two lip portions 22 are formed on each of two sidewalls 23 of the outer tire 20. The lip portions 22 are engaged with a wheel rim 41.

An inner member 30 is located inside of the outer tire 20 and two peripheral edges 31 of the inner member 30 are adhered to two opposite insides of the two sidewalls 23 of the outer tire 20. The positions where the two peripheral edges 31 of the inner member 30 are connected to the insides of the sidewalls 23 are located above the two respective lip portions 22. Before a sulfuirizing process is proceeded to the tire of the present invention, a releasing agent is spread or coated on the inner surface of the inner member 30 and an inner surface of the outer tire 20 except the positions where the two peripheral edges 31 of the inner member 30 are to be adhered to the insides of the sidewalls 23. Because the peripheral edges 31 of the inner member 30 and the insides of the sidewalls 23 are sticky before sulfirizing process, they are adhered as a one-piece member after the sulfurizing process is proceeded. The portions that is covered by the releasing agent of the outer tire 20 and the inner member 30 will be separated from each other after the sulfurizing process is proceeded.

A valve 40 is connected to the inner member 30 and communicates with a space defined between the outer tire 20 and the inner member 30. The valve 40 is located at a position where has an equal distance to the two peripheral edges 31 of the inner member 30.

As shown in FIG. 2, when air pressure enters into the space between the outer tire 20 and the inner member 30 via the valve 40 which is inserted through an aperture defined through the wheel rim 41, the space between the outer tire 20 and the inner member 30 is expanded and plays a role as the inner tube to maintain the shape of the outer tire 20. During the inflation, the valve 40 is pushed by the pressure to extend through the wheel rim 41 as shown. Only two peripheral edges 31 of the inner member 30 are securely connected to the inside of the sidewalls 23 of the outer tire 20. Accordingly, the tire is an inner-tube-free tire.

It is to be noted that the inner member 30 and the outer tube 20 are made in one process during the sulfurizing process so that the manufacturers do not need to manufacture the outer tire 20 and the inner tube in two different production lines. The assemblers do not need to install the inner tube in the outer tire one by one so that the tire structure of the present invention saves very much of time. This is important for the bicycles assemblers.

Besides, when the space between the outer tire 20 and the inner member 30 is expanded, the inner member 30 contacts the inside of the rim 41 only a very limited area so that the heads of the spokes on the inside of the rim 41 will not penetrate the inner member 30. This means the protection strip wrapped around the inside of the rim to separate the inner tube and the heads of the spokes as used in conventional tire structure with inner tube can be saved.

No pressing members are needed to press the peripheral edges 31 of the inner member 30 and the processes for manufacturing the tire structure of the present invention is simple and effective. The tire structure of the present invention can be satisfactorily used in bicycle tires.

While we have shown and described various embodiments in accordance with the present invention, it should be clear to those skilled in the art that further embodiments may be made without departing from the scope and spirit of the present invention.

What is claimed is:

1. A tire structure comprising:
an outer tire including a tread and two sidewalls extending from two sides of said tread, a lip portion formed on each of two sidewalls of said outer tire, said lip portions adapted to be engaged with a wheel rim;
an inner member located inside of said outer tire and two peripheral edges of said inner member connected between two opposite insides of said two sidewalls of said outer tire, said positions where said two peripheral edges of said inner member are connected to said insides of said sidewalls are located above said two respective lip portions, and
a valve connected to said inner member and communicating with a space defined between said outer tire and said inner member.

2. The tire structure as claimed in claim 1, wherein said valve is located at a position where has an equal distance to said two peripheral edges of said inner member.

3. The tire structure as claimed in claim 1, wherein said two peripheral edges of said inner member are adhered to said insides of said sidewalls of said outer tire during sulfurizing process when manufacturing the tire.

4. The tire structure as claimed in claim 1, wherein a releasing agent is spread on an inner surface of said inner member and an inner surface of said outer tire except for said two peripheral edges of said inner member.
